(19) United States
(12) Patent Application Publication
(10) Pub. No.: US 2008/0143785 A1
(43) Pub. Date: Jun. 19, 2008

(54) INKJET IMAGE FORMING METHOD AND APPARATUS, AND INK COMPOSITION THEREFOR

(76) Inventor: Hiroaki Houjou, Kanagawa-ken (JP)

Correspondence Address: BIRCH STEWART KOLASCH & BIRCH, PO BOX 747, FALLS CHURCH, VA, 22040-0747, US

(21) Appl. No.: 11/955,943

(22) Filed: Dec. 13, 2007

(30) Foreign Application Priority Data
Dec. 15, 2006 (JP) 2006-339034

(51) Int. Cl. G03G 15/00

(52) U.S. Cl. 347/45

(57) ABSTRACT

An inkjet image forming method of forming an image on a recording medium includes the step of ejecting an ink composition through a nozzle hole onto the recording medium so that the image is formed on the recording medium. The ink composition contains coloring material particles and polymer particles, the polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5; and the nozzle hole is provided in a nozzle plate which is uniformly coated with an ink repelling film on a front surface of the nozzle plate, an inner surface of the nozzle hole and a part of a rear surface of the nozzle plate surrounding the nozzle hole, the ink repelling film having properties to repel the ink composition.

### BACKGROUND OF THE INVENTION

1. Field of the Invention

The present invention relates to an inkjet image forming method and apparatus, and an ink composition used therein.

2. Description of the Related Art

An inkjet image forming apparatus has been known and used widely as a data output apparatus for outputting an image, document, or the like. The inkjet image forming apparatus has a print head which ejects ink through nozzles to form an image, document, or the like on a recording medium according to print data by driving corresponding actuators provided for the nozzles in accordance with the print data.

As to such an inkjet image forming apparatus, in order to prevent deterioration of the ejection characteristics of the ink, it is necessary to carry out cleaning of the nozzles. Moreover, there are problems in relation to variation in the ejection direction of the ink droplets, and it is necessary to take account of the fixing characteristics and the wear resistance characteristics of the ink on the recording medium.

For example, Japanese Patent Application Publication No. 05-116327 discloses a nozzle plate in which a film composed of an ink-repelling fluorine-based polymer material is formed uniformly over the front surface of the nozzle plate, the inner surfaces of the nozzle holes which continue onto the front surface of the nozzle plate, and the peripheral regions of the nozzle holes which continue onto the rear surface of the nozzle plate. By this means, it is possible to prevent the variation in the direction of flight of the ink droplets, and the ejection timing of the ink droplets.

Japanese Patent Application Publication No. 2001-030616 discloses an ink composition to be used which contains a resin emulsion having a minimum film forming temperature of not higher than 20° C. By this means, it is possible to improve image quality, in other words, wear resistance and fixing characteristics, on non-absorbent recording medium.

Japanese Patent Application Publication No. 06-008416 discloses a method of ejecting droplets of ink containing an insoluble component in water, from a print head having been subjected to water repellent treatment. It is therefore possible to clean the print head by means of a well known cleaning method, even though the ink contains such a component that is insoluble in water.

Japanese Patent Application Publication No. 09-286941 describes a method which uses a nozzle plate that has been subjected to water repellent treatment by plating a film containing a fluorine-based polymer on the surface of the nozzle plate, and which uses an ink containing an inorganic oxide colloid. By this means, it is possible to improve the wear resistance, and prevent color variation in the printed object, as well as improving ejection stability.

However, in the technology disclosed in Japanese Patent Application Publication No. 05-116327, it is difficult to adequately prevent soiling caused by residual ink in the vicinity of the nozzle holes. Therefore, if used for a long period of time, residual ink accumulates in the vicinity of the nozzle holes, ejection characteristics deteriorate, and the cleaning load increases. Moreover, when the water repellent film is formed in such a manner that the water repelling material intrudes inside the nozzle holes, then there are also cases where the meniscus surface of the ink in the nozzle hole may be drawn in deeply inside the nozzle hole immediately after ink ejection. In this case, problems may occur in that bubbles (i.e., air bubbles) are drawn in, the ejection direction of the ink droplet varies due to the effects of the bubbles, or ink ejection may become impossible.

In the ink composition described in Japanese Patent Application Publication No. 2001-030616, the wear resistance of the image is improved, but since the ink contains a resin component having film forming characteristics, then the ink forms a film if residual ink is left in the vicinity of the nozzle holes, resulting in the degradation of the ink ejection characteristics. Moreover, a problem also arises in that the cleaning load is increased. Furthermore, if polymer particles are added in excessive quantity in order to improve the wear resistance, the ejection reliability deteriorates markedly and the cleaning load also increases markedly.

In the ink composition disclosed in Japanese Patent Application Publication No. 06-008416, since the ink contains a hydrophilic base resin component, it is possible to avoid the soiling caused by the residual ink material in the vicinity of the nozzles, and it is possible to reduce the cleaning load. However, there are cases where the ink meniscus retreats inside the nozzle holes, and it is difficult to resolve the problem of the variation in the ink ejection direction.

Japanese Patent Application Publication No. 09-286941 requires that the amount of inorganic oxide is suppressed in order to restrict variation in the ejection direction. However, in order to ensure the resistance to wear, it is necessary to include a large amount of inorganic oxide, and therefore it is difficult to achieve both the wear resistance and the ejection stability, at the same time. Moreover, it is difficult to resolve the problem of the variation in the ink ejection direction caused by the retreat of the meniscus surface.

As described above, in the apparatus or ink composition described in Japanese Patent Application Publication Nos. 05-116327, 2001-030616, 06-008416 and 09-286941, although it is possible to improve the nozzle cleaning characteristics, the variation in the ejection direction, or the wear resistance and fixing characteristics, it is difficult to improve all of these factors.

### SUMMARY OF THE INVENTION

The present invention has been contrived in view of these circumstances, an object thereof being to provide an inkjet image forming method, an inkjet image forming apparatus and an ink composition whereby the nozzle cleaning characteristics, the ejection stability, the ink fixing characteristics, and the wear resistance are all improved.

In order to attain the aforementioned object, the present invention is directed to an inkjet image forming method of forming an image on a recording medium, comprising the step of: ejecting an ink composition through a nozzle hole onto the recording medium so that the image is formed on the recording medium, wherein: the ink composition contains coloring material particles and polymer particles, the polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5; and the nozzle hole is provided in a nozzle plate which is uniformly coated with an ink repelling film on a front surface of the nozzle plate, an inner surface of the nozzle hole and a part of a rear surface of the nozzle plate surrounding the nozzle hole, the ink repelling film having properties to repel the ink composition.

In this aspect of the present invention, since the nozzle plate has an ink repelling film formed on the front surface of the nozzle plate, the inner surfaces of the nozzle holes, and the peripheral regions which continue to the rear surface of the nozzle plate, then it is possible to form a uniform ink meniscus shape inside the nozzle holes and therefore ink droplets can be ejected in a uniform state.

Moreover, by setting the minimum film forming temperature (MFT) of the polymer particles to 25° C. or lower, it is possible to absorb force applied to the image film when it is rubbed, and therefore the wear resistance characteristics and the fixing characteristics can be improved. Moreover, a beneficial effect is obtained in that a thin film having an appropriate brittleness can be formed at the ink meniscus surface in the nozzles.

Furthermore, by using polymer particles including an anionic hydrophilic group in the ink composition, the non-affinity with respect to the ink repelling film formed on the nozzle plate is increased, and therefore the ink residue due to the ink wetting the perimeter edge portion of the nozzle hole can be reduced, and the cleaning load relating to the nozzle plate can be reduced. Moreover, a beneficial effect is also obtained in raising the adhesive force with respect to the recording medium, and therefore it is possible to improve the fixing characteristics of the ink.

Since the ratio Mv/Mn of the volume-average particle size Mv with respect to the number-average particle size Mn of the polymer particles contained in the ink composition is not less than 1 and not greater than 1.5, then it is possible to prevent the occurrence of relatively large and coarse particles in the polymer particles, and therefore it is possible to form a uniform thin film at the meniscus. If such relatively large and coarse particles are present, then since film formation only progresses in the vicinity of the large coarse particles, it is difficult to obtain a uniform thin film.

By satisfying all of the conditions described above, it is possible to prevent both the ink wetting at the periphery of the nozzles, and the excessive retreat of the ink meniscus inside the nozzles.

The thin film composed of the polymer particles and formed at the meniscus is held at a suitable position whereby the meniscus does not cause the above-described problems, and moreover, it serves to prevent evaporation of ink solvent which is exposed to the outside air at the meniscus. Consequently, there is no decrease in the ejection speed as a result of increased viscosity, and satisfactory ejection stability can be achieved.

By this means, it is possible to provide an inkjet image forming method whereby the nozzle cleaning characteristics, the ejection stability, the ink fixing characteristics and the ink wear resistance can all be improved.

Preferably, the ratio Mv/Mn is not less than 1 and not greater than 1.35.

In this aspect of the present invention, by reducing the breadth of the particle size distribution of the polymer particles, it is possible to form a thin film to cover the ink meniscus surface, in a more uniform fashion.

Preferably, the anionic hydrophilic functional group includes a carboxyl group.

In this aspect of the present invention, it is possible to improve the fixing characteristics of the ink composition on the recording medium. Moreover, it is also possible to increase the non-affinity with respect to the nozzles imparted with the ink-repelling characteristics, and therefore residual material on the nozzle plate can be reduced, and the cleaning load for the nozzles can also be reduced.

Preferably, the ink repelling film contains a fluoropolymer.

In this aspect of the present invention, the ink-repelling characteristics of the nozzle plate can be improved, and therefore it is possible to reduce the residue on the nozzle plate and thereby to reduce the cleaning load for the nozzles.

Preferably, the nozzle plate has a curved surface at a boundary between the inner surface of the nozzle hole and the front surface of the nozzle plate.

In this aspect of the present invention, since the boundary between the inner surface of the nozzle hole and the front surface of the nozzle plate is formed by a curved surface, then it is possible to avoid the accumulation of the ink residue in the peripheral regions of the nozzles, and therefore the cleaning load for the nozzles can be reduced.

Preferably, the nozzle plate has a curved surface at a boundary between the inner surface of the nozzle hole and the rear surface of the nozzle plate. In this aspect of the present invention, it is possible to form the ink meniscus at a uniform position, and therefore variation in the ink ejection direction can be restricted.

Preferably, the polymer particles have a glass transition temperature Tg of not higher than 50° C.

By setting the glass transition temperature (Tg) of the polymer particles to be 50° C. or lower, it is possible to ensure that a thin film formed at the ink meniscus has a fragility whereby it is readily breakable. Therefore, it is possible to suppress the variation in the ink ejection direction.

Preferably, the polymer particles have the volume-average particle size of not greater than 100 nm.

In this aspect of the present invention, it is possible to reduce the number of large coarse particles, and even if particles having a relatively large size in the particle size distribution are present, it is possible to reduce the effects of these particles on the uniformity of the film. Consequently, a uniform thin film can be formed at the ink meniscus, and therefore it is possible to stabilize the ink ejection direction. Moreover, since accumulation of material in the peripheral regions of the nozzles can be reduced, then the cleaning load can also be reduced.

Preferably, the coloring material particles have a volume-average particle size of not greater than 100 nm.

In this aspect of the present invention, since the volume-average particle size of the coloring material particles is small, then it is possible to reduce accumulation of material in the peripheral regions of the nozzles, as well as reducing the cleaning load.

Preferably, the polymer particles have the volume-average particle size not greater than a volume-average particle size of the coloring material particles.

In this aspect of the present invention, by making the volume-average particle size of the polymer particles equal to or less than the volume-average particle size of the coloring material particles, the collision frequency between the polymer particles is not liable to be impeded by the coloring material particles, and therefore it is possible to form a film satisfactorily at the ink meniscus. Moreover, when ink droplets are deposited on the recording medium, since the polymer particles become more liable to enter in between the coloring material particles, it is possible to improve the fixing properties and the wear resistance properties due to improvement in the bonding effect between the coloring material particles as a result of film formation.

In order to attain the aforementioned object, the present invention is also directed to an inkjet image forming apparatus which ejects an ink composition onto a recording medium to form an image on the recording medium, the inkjet image forming apparatus comprising: a nozzle plate provided with a nozzle hole through which the ink composition is ejected, the nozzle plate being uniformly coated with an ink repelling film on a front surface of the nozzle plate, an inner surface of the nozzle hole and a part of a rear surface of the nozzle plate surrounding the nozzle hole, the ink repelling film having properties to repel the ink composition, wherein the ink composition contains coloring material particles and polymer particles, the polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5.

In this aspect of the present invention, beneficial effects similarly to the above-described inkjet image forming method can be obtained.

In order to attain the aforementioned object, the present invention is also directed to an ink composition used in an inkjet image forming apparatus which includes a nozzle plate provided with a nozzle hole, the nozzle plate being uniformly coated with an ink repelling film on a front surface of the nozzle plate, an inner surface of the nozzle hole and a part of a rear surface of the nozzle plate surrounding the nozzle hole, the ink repelling film having properties to repel the ink composition, the ink composition comprising: coloring material particles; and polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5.

In this aspect of the present invention, since the nozzle plate has an ink-repelling film formed on the front surface of the nozzle plate, the inner surfaces of the nozzle holes, and the peripheral regions which continue to the rear surface of the nozzle plate, then it is possible to form a uniform ink meniscus shape inside the nozzle holes and therefore ink droplets can be ejected in a uniform state.

Moreover, by setting the minimum film forming temperature (MET) of the polymer particles to 25° C. or lower, it is possible to absorb force applied to the image film when it is rubbed, and therefore the wear resistance characteristics and the fixing characteristics can be improved. Moreover, a beneficial effect is obtained in that a thin film having an appropriate brittleness can be formed at the ink meniscus surface in the nozzles.

Furthermore, by using an anionic hydrophilic group in the ink composition, the non-affinity with respect to the ink repelling film formed on the nozzle plate is increased, and therefore the ink residue due to the ink wetting the perimeter edge portion of the nozzle hole can be reduced, and the cleaning load relating to the nozzle plate can be reduced. Moreover, a beneficial effect is also obtained in raising the adhesive force with respect to the recording medium, and therefore it is possible to improve the fixing characteristics of the ink.

Since the ratio Mv/Mn of the volume-average particle size Mv with respect to the number-average particle size Mn of the polymer particles contained in the ink composition is not less than 1 and not greater than 1.5, then it is possible to prevent the occurrence of relatively large and coarse particles in the polymer particles, and therefore it is possible to form a uniform thin film at the meniscus, and the ink ejection characteristics can be stabilized.

By satisfying all of the conditions described above, it is possible to prevent both the ink wetting at the periphery of the nozzles and the excessive retreat of the ink meniscus inside the nozzles.

The thin film created by the polymer particles and formed at the meniscus is held at a suitable position whereby the meniscus does not cause the above-described problems, and furthermore, it serves to prevent evaporation of ink solvent which is exposed to the outside air at the meniscus. Consequently, there is no decrease in the ejection speed as a result of increased viscosity, and satisfactory ejection stability can be achieved.

By this means, it is possible to provide an ink composition having excellent nozzle cleaning characteristics, ejection stability, ink fixing characteristics and ink wear resistance.

According to the present invention, it is possible to provide an inkjet image forming method and apparatus, and an ink composition, having excellent nozzle cleaning characteristics, ejection stability, ink fixing characteristics and ink wear resistance.

### BRIEF DESCRIPTION OF THE DRAWINGS

The nature of this invention, as well as other objects and advantages thereof, will be explained in the following with reference to the accompanying drawings, in which reference characters designate the same or similar parts throughout the figures and wherein:

FIG. 1 is a general schematic drawing showing a general view of an inkjet image forming apparatus according to an embodiment of the present invention;

FIG. 2 is a principal plan diagram of the peripheral area of a print unit in the inkjet image forming apparatus shown in FIG. 1;

FIG. 3 is a plan view perspective diagram showing an example of the composition of a print head;

FIG. 4 is a cross-sectional view along line 4-4 in FIG. 3;

FIGS. 5A to 5E are diagrams showing steps for forming an ink-repelling film on the front surface of the nozzle plate;

FIGS. 6A to 6C are diagrams showing a further coating method for coating on the rear surface of the nozzle plate;

FIG. 7 is a diagram showing cross-sectional diagrams of nozzle plates used in practical examples; and

FIGS. 8 to 12 are diagrams showing evaluation results of the practical examples.

### DETAILED DESCRIPTION OF THE PREFERRED EMBODIMENTS

### General Composition of Inkjet Image Forming Apparatus

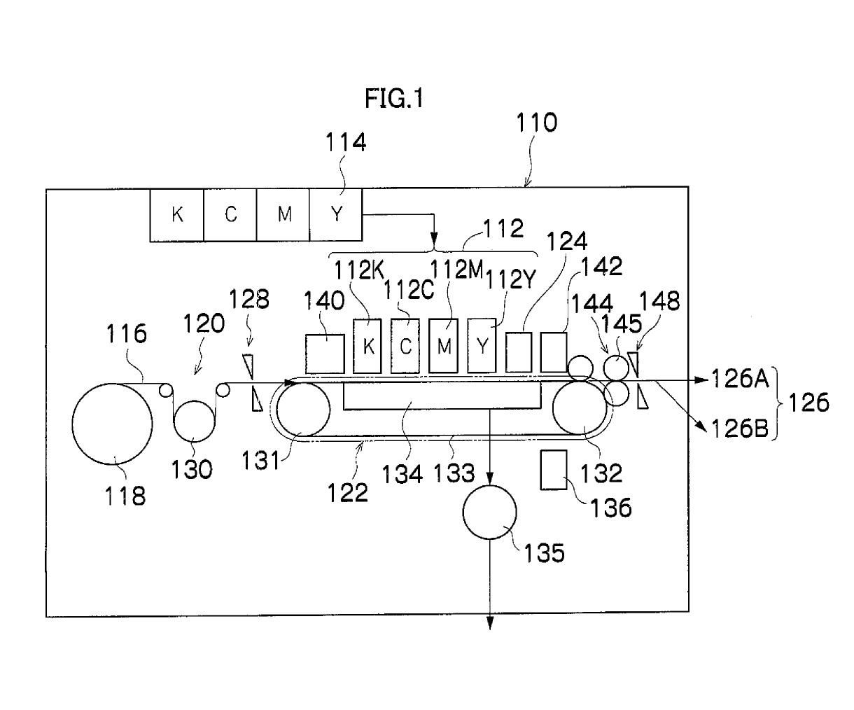

FIG. 1 is a general configuration diagram of an inkjet image forming apparatus according to an embodiment of the present invention. As shown in FIG. 1, the inkjet image forming apparatus 110 includes; a print unit 112 having a plurality of inkjet heads (hereafter referred to as “heads”) 112K, 112C, 112M, and 112Y provided for ink colors of black (K), cyan (C), magenta (M), and yellow (Y), respectively; an ink storing and loading unit 114 for storing inks of K, C, M and Y to be supplied to the print heads 112K, 112C, 112M, and 112Y; a paper supply unit 118 for supplying recording paper 116 which is a recording medium; a decurling unit 120 removing curl in the recording paper 116; a belt conveyance unit 122 disposed facing the nozzle face (ink-droplet ejection face) of the print unit 112, for conveying the recording paper 116 while keeping the recording paper 116 flat; a print determination unit 124 for reading the printed result produced by the print unit 112; and a paper output unit 126 for outputting image-printed recording paper (printed matter) to the exterior.

The ink storing and loading unit 114 has ink tanks for storing the inks of K, C, M, and Y to be supplied to the heads 112K, 112C, 112M, and 112Y, and the tanks are connected to the beads 112K, 112C, 112M, and 112Y by means of prescribed channels. The ink storing and loading unit 114 has a warning device (for example, a display device or an alarm sound generator) for warning when the remaining amount of any ink is low, and has a mechanism for preventing loading errors among the colors.

In FIG. 1, a magazine for rolled paper (continuous paper) is shown as an example of the paper supply unit 118; however, more magazines with paper differences such as paper width and quality may be jointly provided. Moreover, papers may be supplied with cassettes that contain cut papers loaded in layers and that are used jointly or in lieu of the magazine for rolled paper.

In the case of a configuration in which a plurality of types of recording media can be used, it is preferable that an information recording medium such as a bar code and a wireless tag containing information about the type of media is attached to the magazine, and by reading the information contained in the information recording medium with a predetermined reading device, the type of recording medium to be used (type of medium) is automatically determined, and ink-droplet ejection is controlled so that the ink-droplets are ejected in an appropriate manner in accordance with the type of medium.

The recording paper 116 delivered from the paper supply unit 118 retains curl due to having been loaded in the magazine. In order to remove the curl, heat is applied to the recording paper 116 in the decurling unit 120 by a heating drum 130 in the direction opposite from the curl direction in the magazine. The heating temperature at this time is preferably controlled so that the recording paper 116 has a curl in which the surface on which the print is to be made is slightly round outward.

In the case of the configuration in which roll paper is used, a cutter (first cutter) 128 is provided as shown in FIG. 1, and the continuous paper is cut into a desired size by the cutter 128. When cut papers are used, the cutter 128 is not required.

The decurled and cut recording paper 116 is delivered to the belt conveyance unit 122. The belt conveyance unit 122 has a configuration in which an endless belt 133 is set around rollers 131 and 132 so that the portion of the endless belt 133 facing at least the nozzle face of the print unit 112 and the sensor face of the print determination unit 124 forms a horizontal plane (flat plane).

The belt 133 has a width that is greater than the width of the recording paper 116, and a plurality of suction apertures (not shown) are formed on the belt surface. A suction chamber 134 is disposed in a position facing the sensor surface of the print determination unit 124 and the nozzle surface of the print unit 112 on the interior side of the belt 133, which is set around the rollers 131 and 132, as shown in FIG. 1. The suction chamber 134 provides suction with a fan 135 to generate a negative pressure, and the recording paper 116 is held on the belt 133 by suction. It is also possible to employ an electrostatic method, instead of the suction method.

The belt 133 is driven in the clockwise direction in FIG. 1 by the motive force of a motor (not shown in drawings) being transmitted to at least one of the rollers 131 and 132, around which the belt 133 is set, and the recording paper 116 held on the belt 133 is conveyed from left to right in FIG. 1.

Since ink adheres to the belt 133 when a marginless print job or the like is performed, a belt-cleaning unit 136 is disposed in a predetermined position (a suitable position outside the printing area) on the exterior side of the belt 133. Although the details of the configuration of the belt-cleaning unit 136 are not shown, examples thereof include: a configuration in which the belt 133 is nipped with cleaning rollers such as a brush roller and a water absorbent roller; an air blow configuration in which clean air is blown onto the belt 133; and a combination of these. In the case of the configuration in which the belt 133 is nipped with the cleaning rollers, it is preferable to make the line velocity of the cleaning rollers different than that of the belt to improve the cleaning effect.

The inkjet recording apparatus 110 can comprise a roller nip conveyance mechanism, instead of the belt conveyance unit 122. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 140 is disposed on the upstream side of the print unit 112 in the conveyance pathway formed by the belt conveyance unit 122. The heating fan 140 blows heated air onto the recording paper 116 to heat the recording paper 116 immediately before printing so that the ink deposited on the recording paper 116 dries more easily.

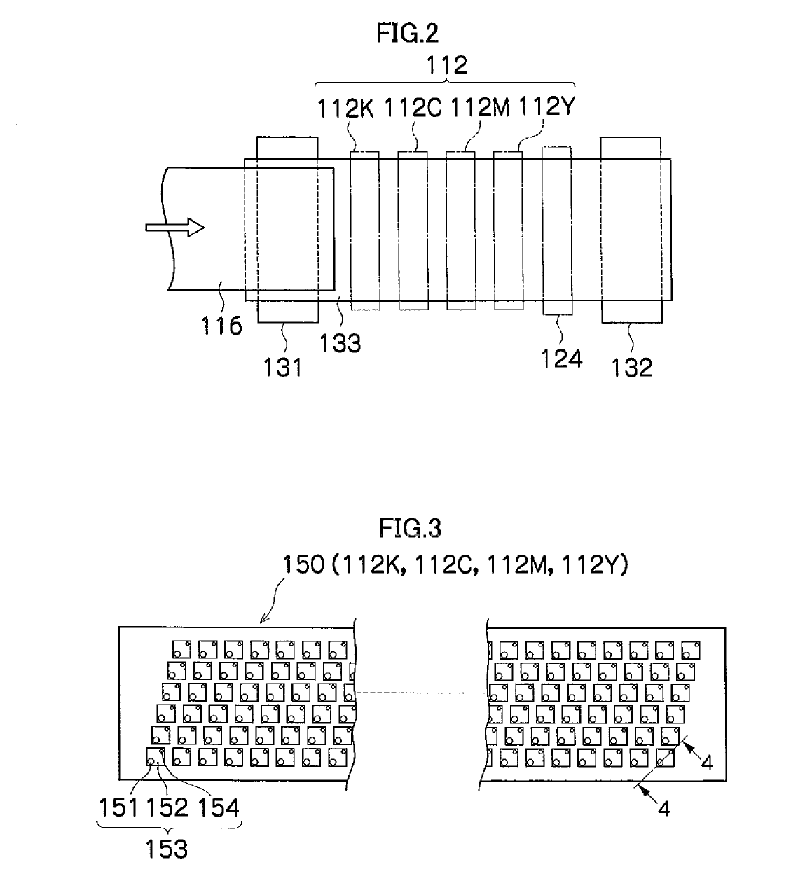

The heads 112K, 112C, 112M, and 112Y of the print unit 112 are full line heads each of which has a length corresponding to the maximum width of the recording paper 116 to be used in the inkjet recording apparatus 110, and each of which comprises a plurality of nozzles for ejecting ink arranged on a nozzle face through a length exceeding at least one edge of the maximum-size recording medium (namely, the full width of the printable range) (see FIG. 2).

The print heads 112K, 112C, 112M, and 112Y are arranged in color order (black (K), cyan (C), magenta (M), yellow (Y)) from the upstream side in the feed direction of the recording paper 116, and these heads 112K, 112C, 112M, and 112Y are fixed extending in a direction substantially perpendicular to the conveyance direction of the recording paper 116.

A color image can be formed on the recording paper 116 by ejecting inks of different colors from the heads 112K, 12C, 112M, and 112Y, respectively, onto the recording paper 116 while the recording paper 116 is conveyed by the belt conveyance unit 122.

By adopting a configuration in which the full line heads 112K, 112C, 112M, and 112Y having nozzle rows covering the full paper width are provided for the respective colors in this way, it is possible to record an image on the full surface of the recording paper 116 by performing just one operation of relatively moving the recording paper 116 and the print unit 112 in the paper conveyance direction (the sub-scanning direction), in other words, by means of a single sub-scanning action. Higher-speed printing is thereby made possible and productivity can be improved in comparison with a shuttle type head configuration in which a recording head reciprocates in the main scanning direction.

Although the configuration with the KCMY four standard colors is described in the present embodiment, combinations of the ink colors and the number of colors are not limited to those. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

The print determination unit 124 shown in FIG. 1 has an image sensor (line sensor or area sensor) for capturing an image of the ink-droplet deposition result of the print unit 112, and functions as a device to check for ejection defects such as clogs of the nozzles and depositing position displacement from the ink-droplet deposition results evaluated by the image sensor.

A CCD area sensor in which a plurality of photoreceptor elements (photoelectric transducers) are arranged two-dimensionally on the light receiving surface is suitable for use as the print determination unit 124 used in the present embodiment. An area sensor has an imaging range which is capable of capturing an image of at least the full area of the ink ejection width (image recording width) of the respective heads 112K, 112C, 112M and 112Y. It is possible to achieve the required imaging range by means of one area sensor, or alternatively, it is also possible to ensure the required imaging range by combining (joining) together a plurality of area sensors. Alternatively, a composition may be adopted in which the area sensor is supported on a movement mechanism (not illustrated), and an image of the required imaging range is captured by moving (scanning) the area sensor.

Furthermore, it is also possible to use a line sensor instead of the area sensor. In this case, a desirable composition is one in which the line sensor has rows of photoreceptor elements (rows of photoelectric transducing elements) with a width that is greater than the ink droplet ejection width (image recording width) of the print heads 112K, 112C, 112M and 112Y.

A test pattern or the target image printed by the print heads 112K, 112C, 112M, and 112Y of the respective colors is read in by the print determination unit 124, and the ejection performed by each head is determined. The ejection determination includes detection of the ejection, measurement of the dot size, and measurement of the dot formation position.

A post-drying unit 142 is disposed following the print determination unit 124. The post-drying unit 142 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming into contact with ozone and other substances that cause dye molecules to break down, and thereby the effect of increasing the durability of the print can be obtained.

A heating/pressurizing unit 144 is disposed following the post-drying unit 142. The heating/pressurizing unit 144 is a device to control the glossiness of the image surface, and the image surface is pressed with a pressure roller 145 having a predetermined uneven surface shape while the image surface is heated, and the uneven shape is transferred to the image surface.

The printed matter generated in this manner is outputted from the paper output unit 126. The target print (i.e., the result of printing the target image) and the test print are preferably outputted separately. In the inkjet recording apparatus 110, a sorting device (not shown) is provided for switching the outputting pathways in order to sort the printed matter with the target print and the printed matter with the test print, and to send them to paper output units 126A and 126B, respectively. When the target print and the test print are simultaneously formed in parallel on the same large sheet of paper, the test print portion is cut and separated by a cutter (second cutter) 148. The paper output unit 126A for the target prints is provided with a sorter for collecting prints according to print orders.

### Structure of Head

Next, the structure of a head is described. The heads 112K, 112C, 112M, and 112Y of the respective ink colors have the same structure, and a reference numeral 150 is hereinafter designated to any of the heads.

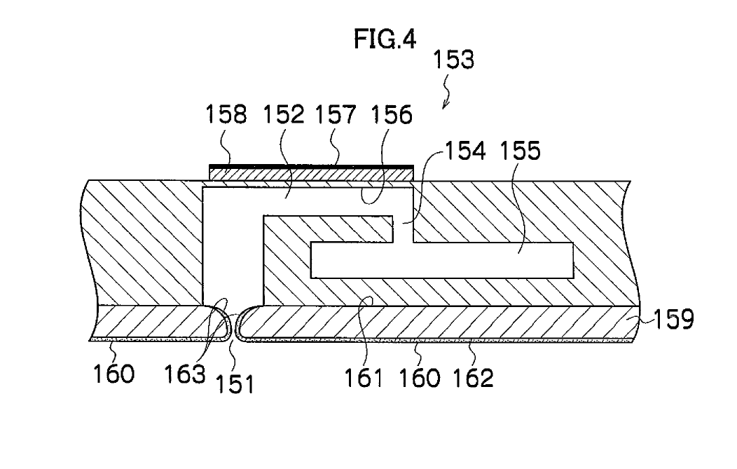

FIG. 3 is a perspective plan view showing an embodiment of the configuration of the head 150, and FIG. 4 is a cross-sectional view taken along the line 4-4 in FIG. 3, showing the three-dimensional structure of one of droplet ejection elements (i.e., one ink chamber unit for one nozzle 151).

The nozzle pitch in the head 150 should be minimized in order to maximize the density of the dots printed on the recording paper 116. As shown in FIG. 3, the head 150 according to the present embodiment has a structure in which a plurality of ink chamber units (droplet ejection elements) 153, each comprising a nozzle 151 forming an ink ejection port, a pressure chamber 152 corresponding to the nozzle 151, and the like, are disposed two-dimensionally in the form of a staggered matrix, and hence the effective nozzle interval (the projected nozzle pitch) as projected in the lengthwise direction of the head (the direction perpendicular to the paper conveyance direction) is reduced and high nozzle density is achieved.

As shown in FIG. 3, the planar shape of the pressure chamber 152 provided corresponding to each nozzle 151 is substantially a square shape, and an outlet port to the nozzle 151 is provided at one of the ends of the diagonal line of the planar shape, while an inlet port (supply port) 154 for supplying ink is provided at the other end thereof. The shape of the pressure chamber 152 is not limited to that of the present embodiment and various modes are possible in which the planar shape is a quadrilateral shape (rhombic shape, rectangular shape, or the like), a pentagonal shape, a hexagonal shape, or other polygonal shape, or a circular shape, elliptical shape, or the like.

As shown in FIG. 4, each pressure chamber 152 is connected to a common channel 155 through the supply port 154. The common channel 155 is connected to an ink tank (not shown), which is a base tank that supplies ink, and the ink supplied from the ink tank is delivered through the common flow channel 155 to the pressure chambers 152.

One wall of each of the pressure chambers 152 (the upper face in FIG. 4) is constituted of a diaphragm 156, and piezoelectric elements 158 are installed on the diaphragm 156 at positions corresponding to the pressure chambers 152. An individual electrode 157 is provided on the upper surface of each of the piezoelectric elements 158. In the present embodiment, the diaphragm 156 is constituted of a conductive material, and it also serves as a common electrode for the piezoelectric elements 158.

By adopting this composition, when a drive voltage is applied to the piezoelectric element 158, pressure is applied to the liquid in the pressure chamber 52 due to the displacement of the piezoelectric element 158, thereby causing a droplet to be ejected from the corresponding nozzle 151. After ejection, liquid is supplied to the pressure chamber 152 from the common flow channel 155.

The method is employed in the present embodiment where an ink droplet is ejected by means of the piezoelectric element 158; however, in implementing the present invention, the method used for discharging ink is not limited in particular, and instead of the piezo jet method, it is also possible to apply various types of methods, such as a thermal jet method by means of an electricity-heat transducer such as a heater.

### Structure of Nozzle Plate

The nozzle hole 151 of the ink chamber unit 153 is formed in a nozzle plate 159. In the present embodiment, an ink-repelling film 160 is formed on a front surface 162 of the nozzle plate 159, an inner surface 163 of the nozzle hole 151 which continues onto the front surface 162, and a peripheral region 164 of the nozzle hole 151 which continues onto the rear surface 161, The nozzle plate 159 may be made of metal, ceramic, silicon, glass, plastic, or the like, and desirably, it is made of an unaolloyed metal, such as titanium, chrome, iron, cobalt, nickel, copper, zinc, tin, gold, or the like, or an alloyed metal, such as nickel-phosphorous alloy, tin-copper-phosphorous alloy (phosphor bronze), copper-zinc alloy, stainless steel, or the like, or polycarbonate, polysulfone, ABS resin (acrylonitrile-butadiene-styrene copolymer), polyethylene terephthalate, polyacetal, and various photosensitive resins.

Preferably, the boundary (namely, the nozzle ejection port edge portion) between the inner surface 163 of the nozzle hole 151 and the front surface 162 of the nozzle plate 159 is formed to have a curved surface. It is thereby possible to form the ink-repelling film 160 to a more uniform film thickness and therefore more uniform ink-repelling characteristics can be obtained. Furthermore, it is also possible to suppress the accumulation of the residual ink about the periphery of the nozzle ejection port. If the edge portion of the ejection port has an angulated shape, then ink is more liable to be left in the edge portion from the front surface 162 to the inner surface 163, and residual ink material becomes more liable to accumulate.

In order to form the ink-repelling film 160 uniformly, it is desirable that the radius of curvature r1 of the curved surface of the nozzle ejection port edge portion be equal to or greater than the thickness (e.g., 1 μm to 10 μm) of the ink-repelling film 160. For example, setting this radius of curvature to be equal to or greater than 1 μm is sufficient in order to achieve the beneficial effect of preventing the ink residue. Even if the accumulated material occurs in the edge portion of the ejection port of the nozzle, it is possible sufficiently to reduce the effects of the accumulated material. On the other hand, in the case of a radius of curvature of 1 μm or less, a sufficiently curved surface shape is not obtained, and the beneficial effect of preventing residue of ink is not displayed sufficiently, thus making accumulation of material more liable to occur.

In a similar fashion, it is also desirable that the boundary between the inner surface 163 of the nozzle hole 151 and the rear surface 161 of the nozzle plate 159 be formed with a curved surface such as a funnel shape, and the like. Similarly to the beneficial effects of the curved surface in the edge portion of the ejection port, in this way, it is possible to form the ink-repelling film 160 to a more uniform film thickness and therefore more uniform ink-repelling characteristics can be obtained. Moreover, if the boundary between the inner surface 163 of the nozzle hole 151 and the rear surface 161 of the nozzle plate 159 is angulated, then when the inner surface 163 of the nozzle hole 151 is filled with the ink liquid from the rear surface 161, variation may arise in the time required for the ink to wet the inner surface 163 of the nozzle hole 151. In this case, since the height position of the ink meniscus is not uniform, then there may be variation in the flight direction of the ink.

Moreover, if the ink meniscus retreats from the inner surface of the nozzle hole 151 toward the rear surface, then since the nozzle plate 159 has the curved surface between the inner surface 163 and the rear surface 161, it is possible to suppress the infiltration of bubbles, and therefore the ink ejection direction can be stabilized.

Similarly to the radius of curvature r1 of the curved surface in the edge portion of the nozzle ejection port, the radius of curvature r2 of the curved surface from the inner surface 163 of the nozzle hole 151 to the rear surface 161 of the nozzle plate 159 is desirably equal to or greater than the thickness (e.g., 1 μm to 10 μm) of the ink-repelling film 160, in order that the ink-repelling film 160 is formed uniformly. Moreover, from the viewpoint of suppressing the infiltration of the bubbles when the height (position) of the ink meniscus moves, it is desirable that the radius of curvature r2 be as close as possible to the nozzle length h (the thickness dimension of the nozzle plate), within a range that does not create problems with the ink ejection or refilling. The nozzle length h is desirably in the range of 10 μm to 100 μm.

Furthermore, the shape of the nozzle plate between the rear surface 161 and the inner surface 163 of the nozzle hole 151 is not restricted to being a funnel shape, and there are no particular limitations on this shape, provided that the cross-sectional area of the nozzle hole 151 decreases in the direction from the rear surface 161 of the nozzle plate toward the nozzle ejection port. For example, it is also possible to adopt a tapered shape.

### Method of Forming Nozzle Plate

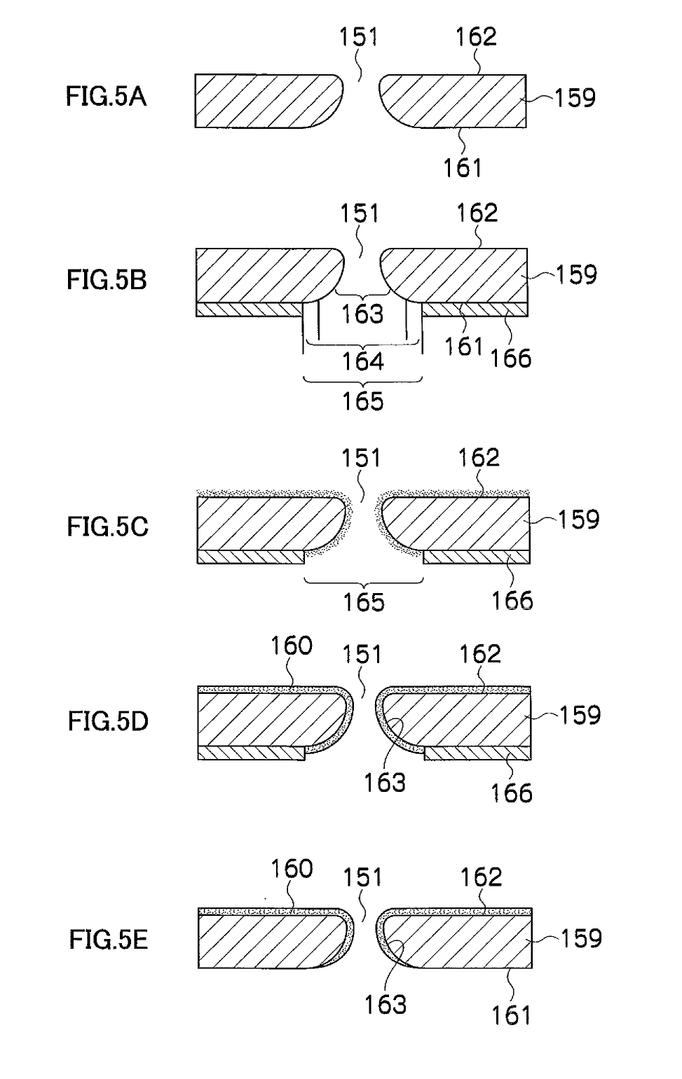

FIGS. 5A to 5E are diagrams showing steps for forming the ink-repelling film 160 on the front surface 162 of the nozzle plate 159.

A resist film 166 is applied appropriately on the rear surface 161 of the nozzle plate 159, apart from the nozzle holes 151 and the peripheral region 164 of the nozzle holes 151 (FIG. 5B). In other words, the resist film 166 provided with a plurality of large-diameter holes 165 which allow exposure of the rear surface 161 from the funnel-shaped portion to the flat portion, and the peripheral region 164 of the nozzle hole 151, is formed on the rear surface 161 of the nozzle plate 159. These holes 165 can also be formed by punching out, or the like, after forming the resist film 166 on the nozzle plate 159.

The nozzle plate 159 on which the resist film 166 has been formed in this way is firstly washed with acid, and then immersed in an electrolyte solution in which nickel ions and particles of hydrophobic polymer resin, such as polytetrafluoroethyelene, are dispersed by electric charge, and eutectic plating is formed on the surface of the nozzle plate 159 while agitating the electrolyte solution (see FIG. 5C).

There are no particular restrictions on the components used in this eutectic plating process, provided that the plating has ink-repelling properties, but desirably it is a fluorine-based polymer (also referred to as “fluoropolymer”) or a silicon-based polymer, and more desirably, it is a fluorine-based polymer. For the fluorine-based polymer, it is possible to use, either independently or in combined fashion, polytetrafluoroethylene, polyperfluoroalkoxy dibutadiene, polyfluorovinylidene, polyfluorovinyl, polydiperfluoroalkyl fumarate, or the like.

There are no particular restrictions on the matrix of this plating layer, and it is possible to choose an appropriate metal, such as nickel, copper, silver, zinc, tin, or the like, but it is desirable to choose a material having high surface hardness and excellent wear resistance, such as nickel or a nickel-cobalt alloy, a nickel-phosphorous alloy, a nickel-boron alloy, or the like.

By this means, the particles of the fluorine-based polymer uniformly adhere together with the nickel ions to the front surface 162 of the nozzle plate 159, the inner surface 163 of the nozzle hole 151 and the portion of the rear surface 161 which is exposed via the respective holes 165 in the resist film 166.

Thereupon, the nozzle plate 159 is heated to a temperature equal to or greater than the melting point of the fluorine-based polymer used, while applying a weight to the nozzle plate 159 in order to prevent the occurrence of warping. By means of this heating, the particles of the fluorine-based polymer reliably melts and unites with the nozzle plate 159, and it is possible to form a smooth ink-repelling film 160 having high hardness.

If the ink-repelling film 160 is thin, then the ink-repelling properties are insufficient, and on the other hand, if it is thick, then this affects the accuracy of the diameter of the ink ejection ports. It is therefore desirable that the ink-repelling film 160 has a film thickness of 1 μm to 10 μm. Moreover, the ink-repelling film 160 preferably contains the fluorine-based polymer of not greater than 60 vol %, and particularly desirably, it contains the fluorine-based polymer of 10 vol % through 50 vol %.

Other possible methods for forming the ink-repelling film 160 include a dip coating method, a spray coating method, or the like, but the eutectic plating method described above is desirable.

Thereupon, the resist film 166 is removed from the rear surface 161 of the nozzle plate 159, and after adhesive is applied on rear surface 161 of the nozzle plate 159, the nozzle plate 159 is attached on a base body, thereby forming the head 150 including ink chamber units 153.

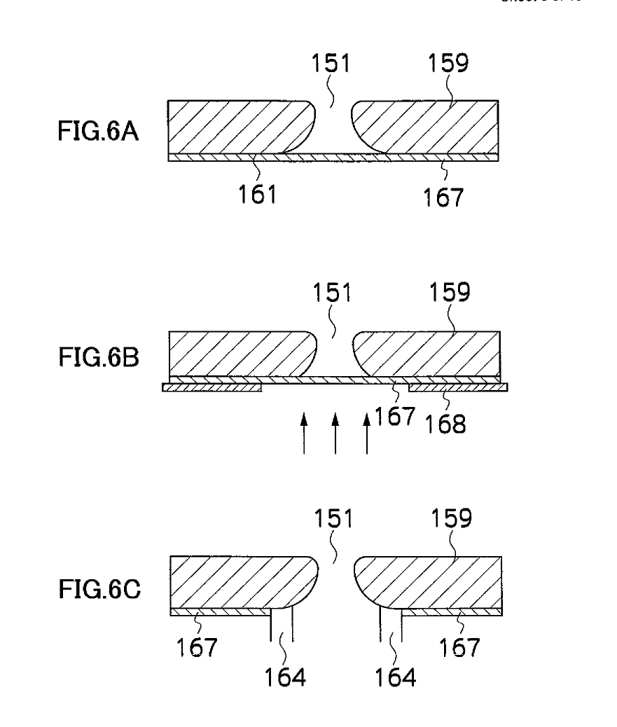

FIGS. 6A to 6C are diagrams showing a further coating method for coating onto the rear surface 161 of the nozzle plate 159.

Similarly to the above-described coating method, in this method, firstly, a liquid resist material 167 is applied on the whole of the rear surface 161 of the nozzle plate 159 (FIG. 6A). Thereupon, by covering the resist material 167 with a mask member 168, exposing the portions of the nozzle holes 151 and the portions 164 peripheral to these (FIG. 6B), and finally, developing and removing the exposed portions, it is possible to cover only the portions on which the adhesive is to be applied, as shown in FIG. 6C.

### Ink Composition

The ink composition in the present embodiment contains at least a coloring material, polymer particles, a water-soluble organic solvent, and water.

### <Coloring Material>

The coloring material in the ink may be a dye, a pigment, or a combination of these. From the viewpoint of improvement of the durability of the printed image, a pigment is desirable for the coloring material in the ink Desirable pigments include: a pigment dispersed by a dispersant, a self-dispersing pigment, a pigment in which the pigment particle is coated with a resin (hereinafter referred to as “micro-capsulated pigment”), and a polymer grafted pigment.

There are no particular restrictions on the resin used for a micro-capsulated pigment, and it is preferable that the resin itself has a self-dispersing capability or solubility, or any of these functions is added or introduced. For example, it is desirable to use a resin having an introduced carboxyl group, sulfonic acid group, or phosphonic acid group or another anionic group, by neutralizing with an organic amine or alkali metal. Moreover, it is also possible to use a resin into which one or two or more anionic groups of the same type or different types have been introduced. In the embodiment of the present invention, it is desirable to use a resin which has been neutralized by means of a salt and which contains an introduced carboxyl group.

Generally, it is desirable that the resin should have a number average molecular weight in the approximate range of 1,000 to 100,000, and especially desirably, in the approximate range of 3,000 to 50,000. Moreover, desirably, this resin can dissolved in an organic solvent to form a solution. By limiting the number average molecular weight of the resin to this range, it is possible to make the resin display satisfactory functions as a covering film for the pigment particle, or as a coating film in the ink composition.

There are no particular restrictions on the pigment used in the present embodiment, and specific examples of orange and yellow pigments are: C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 17, C. I. Pigment Yellow 74, C. I. Pigment Yellow 93, C. I. Pigment Yellow 94, C. I. Pigment Yellow 128, C. I. Pigment Yellow 138, C. I. Pigment Yellow 151, C. I. Pigment Yellow 155, C. I. Pigment Yellow 180, and C.I. Pigment Yellow 185.

Specific examples of red and magenta pigments are: C. I. Pigment Red 2, C. I. Pigment Red 3, C. I. Pigment Red 5, C. I. Pigment Red 6, C. I. Pigment Red 7, C.I. Pigment Red 15, C. I. Pigment Red 16, C.I. Pigment Red 48:1, C. I. Pigment Red 53:1, C.I. Pigment Red 57:1, C. I. Pigment Red 122, C. I. Pigment Red 123, C.I. Pigment Red 139, C. I. Pigment Red 144, C.I. Pigment Red 149, C. I. Pigment Red 166, C. I. Pigment Red 177, C. I. Pigment Red 178, and C.I. Pigment Red 222.

Specific examples of green and cyan pigments are: C.I. Pigment Blue 15, C. I. Pigment Blue 15:2, C. I. Pigment Blue 15:3, C.I. Pigment Blue 16, C. I. Pigment Blue 60, and C.I. Pigment Green 7.

Specific examples of a black pigment are: C.I. Pigment Black 1, C.I. Pigment Black 6, and C.I. Pigment Black 7.

The concentration of the coloring material contained in the ink in the present embodiment is set to an appropriate value in accordance with the coloring material used. The percentage of the coloring material in the ink is preferably 0.1 wt % through 40 wt %, more desirably 1 wt % through 30 wt %, and even more desirably 2 wt % through 20 wt %.

The volume-average particle size of the coloring material particles is not limited in particular provided that it does not impart the ink ejection characteristics, but it is desirable that the coloring material particles have a volume-average particle size of not greater than 100 nm. In addition to the well known beneficial effects of improving coloration and transparency on the recording medium obtained by reducing the size of the coloring material, it is also possible to reduce the accumulation of the ink residue which adheres to the peripheral regions of the nozzles in the head. Moreover, due to a synergistic effect with the shape of the nozzle shape in which the ejection port has a curved surface, it is possible to expect beneficial effects in reducing the cleaning load.

### <Polymer Particle>

It is desirable in the present embodiment that the ink composition contains polymer particles that do not contain any colorant. In particular, a highly dispersible and stable ink can be obtained by adding anionic polymer particles to the ink.

The method of dispersing the polymer particles in the ink is not limited to adding an emulsion of the polymer particles to the ink, and the resin may also be dissolved, or included in the form of a colloidal dispersion, in the ink. Moreover, the polymer particles may be one in which the polymer particles are dispersed by using an emulsifier, or one in which the polymer particles are dispersed without using any emulsifier. For the emulsifier, a surface active agent of low molecular weight is generally used, and it is also possible to use a surface active agent of high molecular weight. It is also desirable to use a capsule type of polymer particles having an outer shell composed of acrylic acid, methacrylic acid, or the like (core-shell type of polymer particles in which the composition is different between the core portion and the outer shell portion).

The polymer particles dispersed without any surface active agent of low molecular weight are known as the soap-free latex, which includes polymer particles with no emulsifier or a surface active agent of high molecular weight. For example, the soap-free latex includes polymer particles that use, as an emulsifier, the above-described polymer having a water-soluble group, such as a sulfonic acid group or carboxyl group (a polymer with a grafted water-soluble group, or a block polymer obtained from a monomer having a water-soluble group and a monomer having an insoluble part).

It is especially desirable in the present embodiment to use the soap-free latex compared to other type of resin particles obtained by polymerization using an emulsifier, since there is no possibility that the emulsifier inhibits the film formation of the polymer particles, or that the free emulsifier moves to the surface after film formation of the polymer particles and thereby degrades the adhesive properties or the fixing properties between the recording medium and the image film in which the coloring material and the polymer particles are combined.

There are no particular restrictions on the anionic hydrophilic functional group used, provided that it has a negative electric charge. Desirable examples of the anionic hydrophilic functional group include: a phosphoric acid group; a phosphonic acid group; a phosphinic acid group; a sulfuric acid group; a sulfonic acid group; a sulfinic acid group or a carboxyl group, and from the viewpoint of imparting the image fixing characteristics to the polymer particles, it is desirable to use a carboxyl group, which has a low degree of disassociation.

Examples of the resin component of the polymer particles include: an acrylic resin, a vinyl acetate resin, a styrene-butadiene resin, a styrene-isoprene resin, a vinyl chloride resin, an acrylic-urethane resin, a styrene-acrylic resin, an ethylene-acrylic resin, a butadiene resin, a styrene resin, and an ionomer resin.

Desirably, the resin constituting the polymer particles is a polymer that has both of a hydrophilic part and a hydrophobic part. By incorporating a hydrophobic part, the hydrophobic part is oriented toward the inner side of the polymer particle, and the hydrophilic part is oriented efficiently toward the outer side, thereby having the effect of imparting a desirable non-affinity effect with respect to the hydrophobic surface of the nozzles, and thus preventing the ink from wetting the perimeter edge portions of the nozzle holes.

Examples of commercially available resin emulsion include: Joncryl (styrene-acrylic resin emulsion, manufactured by Johnson Polymer), Jurymer ET-410 (acrylic resin emulsion, manufactured by Nihon Junyaku), A-104 (acrylic resin emulsion, manufactured by To a Gosei), Zaikthene (ethylene-acrylic resin emulsion, manufactured by Sumitomo Seika Chemicals), and Chemipearl (ethylene-acrylic resin emulsion, manufactured by Mitsui Chemicals).

The weight ratio of the polymer particles to the coloring material is desirably 2:1 through 1:10, and more desirably 1:1 through 1:5. If the weight ratio of the polymer particles to the coloring material is less than 2:1, then there is no substantial improvement by the cohesion of the polymer particles. On the other hand, if the weight ratio of the polymer particles to the coloring material is greater than 1:10, the viscosity of the ink becomes too high and the ejection characteristics, and the like, deteriorate.

From the viewpoint of the adhesive force after the cohesion, it is desirable that the molecular weight of the polymer particles added to the ink is no less than 5,000. If it is less than 5,000, then beneficial effects are insufficient in terms of achieving good abrasion resistance and fixing characteristics.

The polymer particles used in the present embodiment have a minimum film forming temperature (MFT) of not higher than 25° C. The minimum film forming temperature is the minimum temperature at which a transparent continuous film is formed when a resin emulsion obtained by dispersing polymer particles in water is spread thinly over a metal plate or aluminum or the like, and the temperature is gradually raised. In the temperature region below the minimum film forming temperature, a film is not formed but a white powder is formed.

By using polymer particles having a minimum film forming temperature of not higher than 25° C., it is possible to improve the resistance to wear; since plastic properties are imparted to the ink image film, and if the ink is rubbed, the applied force is absorbed by the image film. Moreover, at the ink meniscus in the nozzles, it is possible to form a thin film having an appropriate brittleness. If, on the other hand, the minimum film forming temperature exceeds 25° C., then the effect of imparting the wear resistance in the region of room temperature declines, and furthermore, a thin film cannot be formed at the ink meniscus in the nozzles.

Moreover, the glass transition temperature Tg of the polymer particles used in the present embodiment is preferably 50° C. or lower. By adopting a glass transition temperature of 50° C. or lower, the thin film formed at the ink meniscus will have a fragility which allows it to be broken readily. If, on the other hand, the temperature exceeds 50° C., then the thin film will have excessive hardness, and hence there is a concern that the ink ejection characteristics will be impaired.

Furthermore, by imparting plastic properties to the ink image film, whereby forces applied to the ink when rubbed is absorbed by the image film, it is possible to improve the wear resistance, and therefore, it is desirable that the glass transition temperature of the polymer particles be equal to or lower than 30° C.

The glass transition temperature Tg of the polymer particles can be calculated by an expression (1) which is expressed as follows:

1/Tg=Σ(Xi/Tgi) (1).

Here, it is supposed that the polymer particles are formed by copolymerizing monomer components of n types, from i=1 to i=n. Xi is the mass fraction of the i-th monomer (mass fractions of X1 to Xn have a following relationship: ΣXi=1), and Tgi is the glass transition temperature (absolute temperature) of the homopolymer of the i-th monomer. Here, Σ is the sum for i=1 to n. Even if the types of constituent monomer are the same, it is still possible to adjust the value of Tg of the polymer particles by varying the compositional ratio of these monomers.

There is no particular restrictions on the volume-average particle size of the polymer particles, provided that it does not impair the ink ejection characteristics, but from the viewpoint of forming a thin film at the ink meniscus, it is desirable that the polymer particles have a volume-average particle size of not greater than 100 nm. By setting this size range, it is possible to form a polymer thin film having a suitable brittleness in the peripheral region of the nozzles. Furthermore, at the same time as being able to reduce the number of large and coarse particles, the overall particle size becomes smaller and finer, and therefore, even if the polymer particles having a relatively large size in the particle size distribution are present, it is still possible to reduce the effects of these particles on the uniformity of the film. Furthermore, since the accumulation of the residual material in the perimeter edge portions of the nozzles can be reduced, then due to the synergistic effect of the nozzle shape in which the ejection ports have a curved surface, it is possible to obtain beneficial effects in reducing the cleaning load.

In respect of the particle size distribution of the polymer particles, the ratio (namely, volume-average particles size Mv/number-average particle size Mn) of the volume-average particle size (Mv) with respect to the number-average particle size (Mn) is desirably equal to or greater than 1 and equal to or less than 1.5, and more desirably, equal to or greater than 1 and equal to or less than 1.35.

Possible methods for measuring the particle size distribution, including the volume-average particle size and the number-average particle size described above are a static light scattering method, a dynamic light scattering method, or centrifugal sedimentation method. Of these, dynamic light scattering method using a laser Doppler effect is particularly desirable, since it enables measurement of the particles down to small sizes. Particle size measurement by means of dynamic light scattering can be carried out using a Microtrac UPA (manufactured by Nikkiso Co., Ltd.). The volume-average particle size is the average particle size weighted according to the particle volume (average particle size weighted with the particle volume fraction), and it is obtained by finding the product of the particle diameter and the particle volume for each individual particle in a group of particles, summing these products together and then dividing this sum total by the overall volume of the particles. In other words, the volume-average particle size is expressed as follows:

Mv=Σ(Fi×Mi⁴/Σ(Fi×Mi³) (2),

where Fi is the number (fraction) of particles having a size of Mi.

The number-average particle size is obtained by finding the sum of the diameters of the individual particles in a group of particles, and then dividing by the total number of particles. The number-average particle size is expressed as follows:

Mn=Σ(Fi×Mi)/ΣFi (3),

where Fi is the number (fraction) of particles having a size of Mi.

The relationship between the volume-average particle size and the number-average particle size is such that the volume-average particle size Mv is equal to or greater than the number-average particle size Mn (namely, volume-average particle size≧number-average particle size). In a group of particles which are all of exactly the same size, both values will be equal, and the ratio (volume-average particle size Mv/number-average particle size Mn) of the volume-average particle size Mv with respect to the number-average particle size Mn is 1. Furthermore, the greater the ratio of the volume-average particle size Mv with respect to the number-average particle size Mn, the broader the particle size distribution. The relationship between the volume-average particle size and the number-average particle size is described on page 119 of “Polymer latex chemistry”, Soichi Muroi, published by Polymer Publication Society.

If large and coarse particles are present in the polymer particles in the ink, this may have an extremely significant effect on the ink ejection reliability and is therefore undesirable. In particular, in cases where polymer particles having film formation characteristics at room temperature are used as in the present embodiment, the effects of large and coarse particles are particularly marked. In other words, if there is a great number of large and coarse particles (if the particle size distribution has a broad shape), then in the nozzles of the head, ejection errors may occur, or even if it does not lead to ejection errors, ink residue forms in the vicinity of the nozzles as a result of the large coarse particles, and variation in the ejection direction of the ink droplets may occur.

The method adopted for removing these large coarse particles may be a commonly known centrifugal separation method, precision filtration method, or the like.

The centrifugal separation method may use a commercial centrifugal separating device. The magnitude of the applied centrifugal force is desirably ten times to 1,000,000 times the acceleration due to gravity.

The filter used in the precision filtration method may employ various types of materials. In other words, suitable filter materials include: cellulose; acetyl cellulose; vinylidene polyfluoride; polyethyl sulfone; polytetrafiluoroethylene; polycarbonate; glass fiber; and polypropylene, for example. Furthermore, desirably, the form of the filter may be either a membrane filter or a depth filter. The hole diameter of the filter used for filtration is desirably, 0.1 μm to 10 μm, more desirably, 0.2 μm to 5 μm, and even more desirably, 0.2 μm to 0.5 μm. Moreover, when carrying out filtration, desirably, after filtering with a filter having a large hole size, filtration is carried out again using a filter having a smaller hole size. If there is a great number of large coarse particles and the filtering characteristics are poor, then it is possible to improve the filtering characteristics by adding a dispersant to the dispersion liquid.

Moreover, two or more types of polymer particles may be used in combination in the ink. It is possible to disperse the polymer particles in the ink, respectively and independently, and it is also possible to adopt a core-shell structure including a core part and a shell part. Furthermore, in addition to a mode in which the shell part completely covers the core part, it is also possible to adopt a mode in which it covers a portion of the core part. Moreover, it is also possible to adopt a mode in which a layer of a second resin component is dispersed as the island structure and enveloped inside a layer of a first resin component, and it is also possible to adopt a mode in which second resin particles are dispersed in a scattered fashion on the surface of polymer micro-particles that is constituted of a first resin layer.

Desirably, the volume-average particle size of the polymer particles is smaller than the volume-average particle size of the coloring material particles. If the average particle size of the coloring material particles is smaller than the average particle size of the polymer particles, then the frequency of collision between the coloring material particles and the polymer particles is high, the frequency of contact and aggregation between polymer particles is reduced, thus preventing the formation of a film at the ink meniscus, and hence there is a possibility of impeding the beneficial effects of the present invention. If, on the other hand, the volume-average particle size of the polymer particles is smaller than the volume-average particle size of the coloring material particles, then the dispersion of the coloring material particles assumes a more stable state than the polymer particles, and therefore the coloring material particles do not affect the formation of a thin film of the polymer particles. Furthermore, the polymer particles become more liable to enter in between the coloring material particles, and improvement in the fixing properties and the wear resistance properties can be expected due to improvement in the bonding effect between the coloring material particles as a result of film formation.

The ratio of the volume-average particle size of the coloring material particles with respect to the volume-average particle size of the polymer particles is desirably 1:1 through 10:1 and more desirably, 3:1 through 10:1. If this ratio exceeds 10:1, and the pigment (coloring material) particle size becomes too large, then the bonding effect between the pigment particles due to the polymer particles becomes insufficient, and the wear resistance is impaired.

### Additives

Examples of the pH adjuster added to the ink in the present embodiment include an organic base and an inorganic alkali base, as a neutralizing agent. In order to improve storage stability of the ink for inkjet recording, the pH adjuster is desirably added in such a manner that the ink for inkjet recording has the pH of 6 through 10.

It is desirable in the present embodiment that the ink contains a water-soluble organic solvent, from the viewpoint of preventing nozzle blockages in the ejection head due to drying. Examples of the water-soluble organic solvent include a wetting agent and a penetrating agent.

Examples of the water-soluble organic solvent in the ink are: polyhydric alcohols, polyhydric alcohol derivatives, nitrous solvents, monohydric alcohols, and sulfurous solvents. Specific examples of the polyhydric alcohols are: ethylene glycol, diethylene glycol, propylene glycol, butylene glycol, triethylene glycol, 1,5-pentane diol, 1,2,6-hexane triol, and glycerin. Specific examples of the derivatives of polyhydric alcohol are: ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monobutyl ether, dipropylene glycol monobutyl ether, and an ethylene oxide adduct of diglycerin. Specific examples of the nitrous solvents are: pyrrolidone, N-methyl-2-pyrrolidone, cyclohexyl pyrrolidone, and triethanol amine. Specific examples of the monohydric alcohols are: ethanol, isopropyl alcohol, butyl alcohol, benzyl alcohol, and the like. Specific examples of the sulfurous solvents are: thio diethanol, thio diglycerol, sulfolane, and dimethyl sulfoxide. Apart from these, it is also possible to use propylene carbonate, ethylene carbonate, or the like.

In the present embodiment, a single type of the organic solvent soluble to water may be used independently, or two or more types of the organic solvent soluble to water may be mixed and used together. The content ratio of the organic solvent soluble to water to the total weight of the ink is desirably no more than 60 wt %. If the content ratio is greater than 60 wt %, then the viscosity of the ink may increase and the ejection characteristics from the ejection head may deteriorate.

The ink according to the present embodiment may contain a surface active agent.

Examples of the surface active agent in the ink include: in a hydrocarbon system, an anionic surface active agent, such as a salt of a fatty acid, an alkyl sulfate ester salt, an alkyl benzene sulfonate salt, an alkyl naphthalene sulfonate salt, a dialkyl sulfosuccinate salt, an alkyl phosphate ester salt, a naphthalene sulfonate/formalin condensate, and a polyoxyethylene alkyl sulfonate ester salt; and a non-ionic surface active agent, such as a polyoxyethylene alkyl ether, a polyoxyethylene alkyl atyl ether, a polyoxyethylene fatty acid ester, a sorbitan fatty acid ester, a polyoxyethylene sorbitan fatty acid ester, a polyoxyethylene alkyl amine, a glycerin fatty acid ester, and an oxyethylene oxypropylene block copolymer. Desirable examples of the surface active agent further include: Surfynols (manufactured by Air Products & Chemicals), which is an acetylene-based polyoxyethylene oxide surface active agent, and an amine oxide type of amphoteric surface active agent, such as N,N-dimethyl-N-alkyl amine oxide.

Moreover, it is also possible to use the surface active agents cited in Japanese Patent Application Publication No. 59-157636, pages 37 to 38, and Research Disclosure No. 308119 (1989). Furthermore, it is also possible to use a fluoride type (alkyl fluoride type), or silicone type of surface active agent such as those described in Japanese Patent Application Publication Nos. 2003-322926, 2004-325707 and 2004-309806. It is also possible to use a surface tension adjuster of this kind as an anti-foaming agent; and a fluoride or silicone compound, or a chelating agent, such as ethylenediamine tetraacetic acid (EDTA), can also be used.

It is desirable in the present embodiment that the ink has the surface tension of 10 mN/m through 50 mN/m; and from the viewpoint of achieving good permeabilities into the permeable recording medium or coping with good wetting properties on the non-permeable recording medium, formation of fine droplets and good ejection properties, the surface tension of the ink is more desirably 15 mN/m through 45 mN/m.

It is desirable in the present embodiment that the ink has the viscosity of 1.0 mPa·s through 20.0 mPa·s.

Apart from the foregoing, according to requirements, it is also possible that the ink contains a pH buffering agent, an anti-oxidation agent, an antibacterial agent, a viscosity adjusting agent, a conductive agent, an ultraviolet absorbing agent, or the like.

### EXAMPLES

The present invention is described in more specific terms below with reference to practical examples.

### Manufacture of Pigment Dispersion

### (Pigment Dispersion A)

A block polymer of ABC (A:B:C=13:4:10 (mol ratio), number average molecular weight=3,000) type including methacrylic acid (A)/benzyl methacrylate (B)/ethoxy triethylene glycol methacrylate (C) was prepared as a polymer dispersant. Thereupon, 30 g of the block polymer (polymer dispersant) was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red—122 and 550 g of deionized water were added to the whole amount of this polymer solution and mixed, and then agitated for 0.5 hour in a disperser machine, thereby yielding a preparatory mixture. Next, this preparatory mixture was introduced into a dual tank with an internal capacity of 2 liters, and while agitating with a disperser blade and cooling by means of cooled water at 18° C., the mixture was subjected to batch irradiation (ultrasonic irradiation) for 30 minutes using an ultrasonic homogenizer US-1200T (manufactured by NIHONSEIKI KAISHA LTD.) with a 36 mm-diameter tip. In this operation, the amplitude of vibration was 28 μm and the energy density of the ultrasonic wave irradiation was 110 W/cm². The pigment dispersion solution A obtained in this fashion had a pigment concentration of 15%, and the volume-average particle size of the pigment particles measured by means of a dynamic light scattering type of particle size measurement device (Microtrac UPA) was 69 nm.

### (Pigment Dispersion B)

A block polymer of ABC type (A:B:C=13:4:10 (mol ratio), number average molecular weight=3,000) including methacrylic acid (A)/benzyl methacrylate (B)/ethoxy triethylene glycol methacrylate (C) was prepared as a polymer dispersant. Thereupon, 30 g of the block polymer (polymer dispersant) was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red —122 and 550 g of deionized water were added to the whole amount of this polymer solution and mixed, and then agitated for 0.5 hour in a disperser machine, thereby yielding a preparatory mixture. Thereupon, the preparatory mixture was subjected to dispersion, for 2 passes, at a pressure of 245 MPa, using an Ultamaizer HJP-25003 (manufactured by Sugino Machine Ltd.). The dispersed solution of pigment thus obtained was taken as pigment dispersion solution B. The pigment dispersion solution B obtained in this fashion had a pigment concentration of 15%, and the volume-average particle size of the pigment particles measured by means of a dynamic light scattering type of particle size measurement device (Microtrac UPA) was 110 nm.

### Manufacture of Ink

### (Manufacture of Inks 1 to 12)

The pigment dispersion solution manufactured above was combined in a prescribed weight ratio (indicated below) with the polymer particle dispersion liquids of various types, glycerine, diethylene glycol, Olfine E1010 (manufactured by Nissin Chemical Industry Co., Ltd.), and deionized water, and the mixture was agitated. Finally, once prepared, the ink was filtered through an acetyl cellulose membrane filter having an average hole size of 0.5 μm (manufactured by FUJIFILM Corporation), thereby removing large coarse particles. The ink prepared using the polymer particles 1 is taken to be ink 1, and the ink prepared using the polymer particles 2 is taken to be ink 2. The same applies to polymer particles 3 to 12.

<Compositional Ratio>
pigment dispersion: 5 wt %
one of polymer particles 1 to 12:10 wt %
glycerin: 20 wt %
diethylene glycol: 10 wt %
Olfine E1010 (manufactured by Nissin Chemical Industry Co., Ltd.). 1 wt %
deionized water: balance

Inks were prepared by using the pigment dispersion A in the case of inks 1 to 10 and 12, and by using the pigment dispersion B in the case of ink 11.

Moreover, the polymer particles described below were used as the polymer particles 1 to 12.

Polymer particle 1: Joncryl 537 (manufactured by Johnson Polymer)

Polymer particle 2: Aron HD-5 (manufactured by To a Gosei)

Polymer particle 3: Ultrasol B400-H (manufactured by Ganz Chemical)

Polymer particles 4 to 7: Zaikthene L (manufactured by Sumitomo Seika Chemicals)

Polymer particle 8: Joncryl 775 (manufactured by Johnson Polymer)

Polymer particle 9: Joncryl 352 (manufactured by Johnson Polymer)

Polymer particles 10 and 11: Joncryl 7600 (manufactured by Johnson Polymer)

Polymer particle 12: Joncryl 1535 (manufactured by Johnson Polymer)

In the practical examples, the ratio (Mv/Mn) of the volume-average particle size Mv with respect to the number-average particle size Mn of the polymer particles was measured by means of a Microtrac UPA (manufactured by Nikkiso Co., Ltd.) in an aqueous dispersion solution containing 10 wt % of polymer particles.

With respect to the Mv/Mn value of the polymer particles 4 to 7, in the manufacture of an aqueous dispersion solution including the polymer particles, the Mv/Mn value is adjusted when filtering the large coarse particles, by means of the rotational speed and time of operation if performing a centrifugal separation method, or by means of the filter hole size or number of filtrations if performing precision filtration with a membrane filter made of acetyl cellulose.

The minimum film forming temperature (MFT) and the glass transition temperature (Tg) of the polymer particles were measured by means of the measurement method described above.

### Manufacture of Nozzle Plate

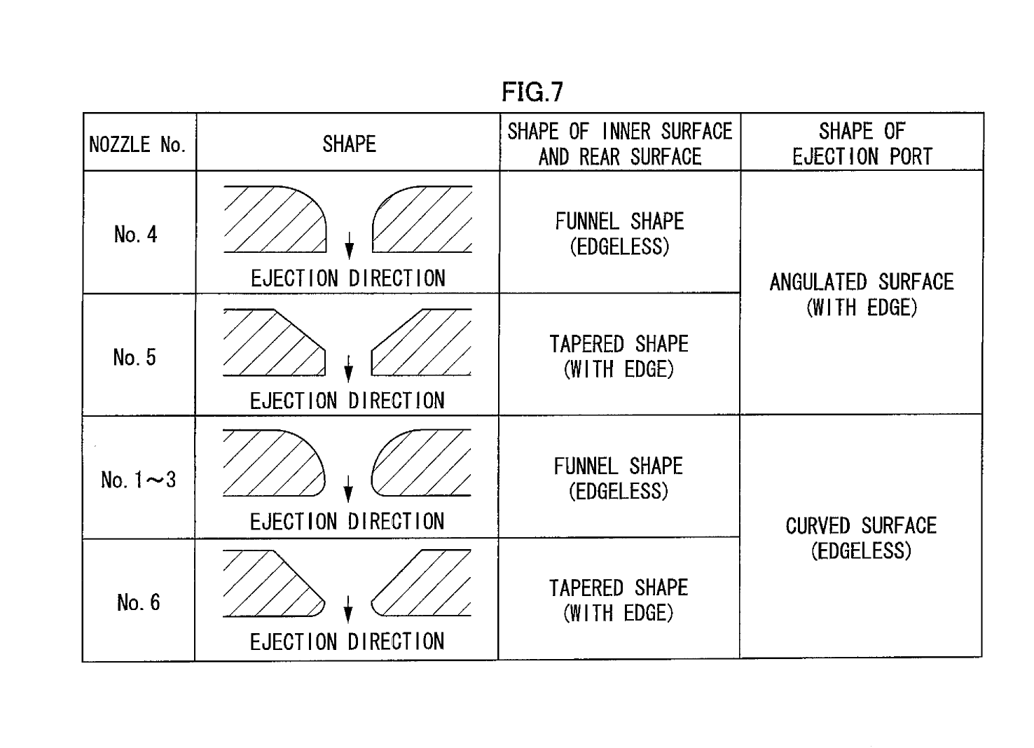

The nozzle plate was manufactured by means of the method shown in FIGS. 5A to 5E. FIG. 7 shows cross-sectional diagrams of nozzle plates used in the practical examples. Nozzles 1 to 4 have an edgeless funnel shape from the inner surface of the nozzle to the rear surface of the nozzle plate, and nozzles 5 and 6 have a tapered shape with an edge. In the case of both the funnel shape and the tapered shape, the cross-sectional area of the ejection port becomes smaller in the direction toward the ink ejection port, but the nozzles 1 to 4 are formed by means of curved lines which project toward the inner portion of the nozzle, from the inner surface of the nozzle to the rear surface. On the other hand, the nozzles 5 and 6 are formed by means of straight lines from the inner surface of the nozzle to the rear surface of the nozzle plate, and the inner portion of the ejection port has a substantially conical shape. Moreover, the shape of the edge portion of the ejection port is an edgeless curved surface in the case of nozzles 1 to 3 and 6, and an angulated surface with an edge in the case of nozzles 4 and 5.

In the case of the nozzle 1, only the front surface of the nozzle plate was subjected to the ink-repelling treatment, resulting in the formation of the ink-repelling film containing a fluoropolymer. In the case of the nozzle 2, the front and rear surfaces of the nozzle plate, and the inner wall of the nozzle hole were subjected to the ink-repelling treatment, resulting in the formation of the ink-repelling film containing a fluoropolymer. In the case of nozzle 3, the front surface of the nozzle plate, the front and rear surfaces of the nozzle plate, and the inner wall of the nozzle hole were subjected to the ink-repelling treatment by using a silicone resin. In the case of nozzles 4 to 6, the front surface of the nozzle plate, the front and rear surfaces of the nozzle plate, and the inner wall of the nozzle hole were subjected to the ink-repelling treatment, resulting in the formation of the ink-repelling film containing a fluoropolymer.

### Evaluation

The prepared inks were deposited at a droplet ejection volume of approximately 7 pl using the head provided with the nozzle plate manufactured as described above, and the following evaluations were made. Tokubishi double-sided art paper (manufactured by Mitsubishi Paper Mills Ltd.) was used as the recording medium for printing.

### (Variation in Ejection Direction)

The ink for evaluation was filled into the head provided with the above-described nozzle plate, text images were printed continuously under conditions of 25° C. and 50 RH, and the time taken until the number of times that a print defect (ink scattering, omitted dots, and the like) appears five times in the printed image, was evaluated.

A: five times not reached even after printing for one day or longer

B: five times reached within one day

C: five limes reached within six hours

D: five times reached within one hour

### (Cleaning Load)

The ink for evaluation was filled into the head provided with the above-described nozzle plate, a nozzle check was carried out, and it was confirmed that droplets of ink were ejected from all of the nozzles, whereupon the head was left for at least one month under conditions of 25° C. and 50 RH, and a similar nozzle check was carried out. The required cleaning load was evaluated on the basis of the number of times that cleaning was required until the print rate was restored to 100%.

A: print rate 100% after one cleaning operation

B: print rate 100% after three cleaning operations

C: print rate 100% after five cleaning operations

D: print rate does not return to 100%, even after five or more cleaning operations

### (Wear Resistance)

In droplet ejection and printing using the above-described nozzles, there were inks which were not ejected satisfactorily from the nozzles, and therefore samples for the evaluation were manufactured by ink coating. The wear resistance was thereby evaluated for each of the inks for evaluation.

The prepared evaluation inks were applied with a bar-coater (#3) onto A6 size Tokubishi art paper, and the coated sample was dried for 24 hours. The samples prepared in this way were taken and a sheet of Tokubishi art paper was placed on top of each of the samples and rubbed back and forth 20 times, while applying a weight of 1.5 kg/cm², under conditions of 25° C. and 50 RH, and the state of detachment of the coloring material from the coated sample was evaluated.

A: absolutely no detachment of coloring material observed in the rubbed portion

B: almost no detachment of coloring material observed in rubbed portion; no problem upon visual observation

C: detachment of coloring material perceived in rubbed portion, but within tolerable range

D: underlying white surface of art paper exposed in some portions; outside tolerable range

### (Fixing Characteristics)

Adhesive tape (manufactured by Nichiban Co., Ltd.) was attached to the coated samples used for the wear resistance evaluation under conditions of 25° C. and 50 RH, and the transfer of color to the tape after detachment of the tape was evaluated.

A: no transfer of color

B: slight transfer of color recognized

C: some degree of color transfer

D: significant color transfer

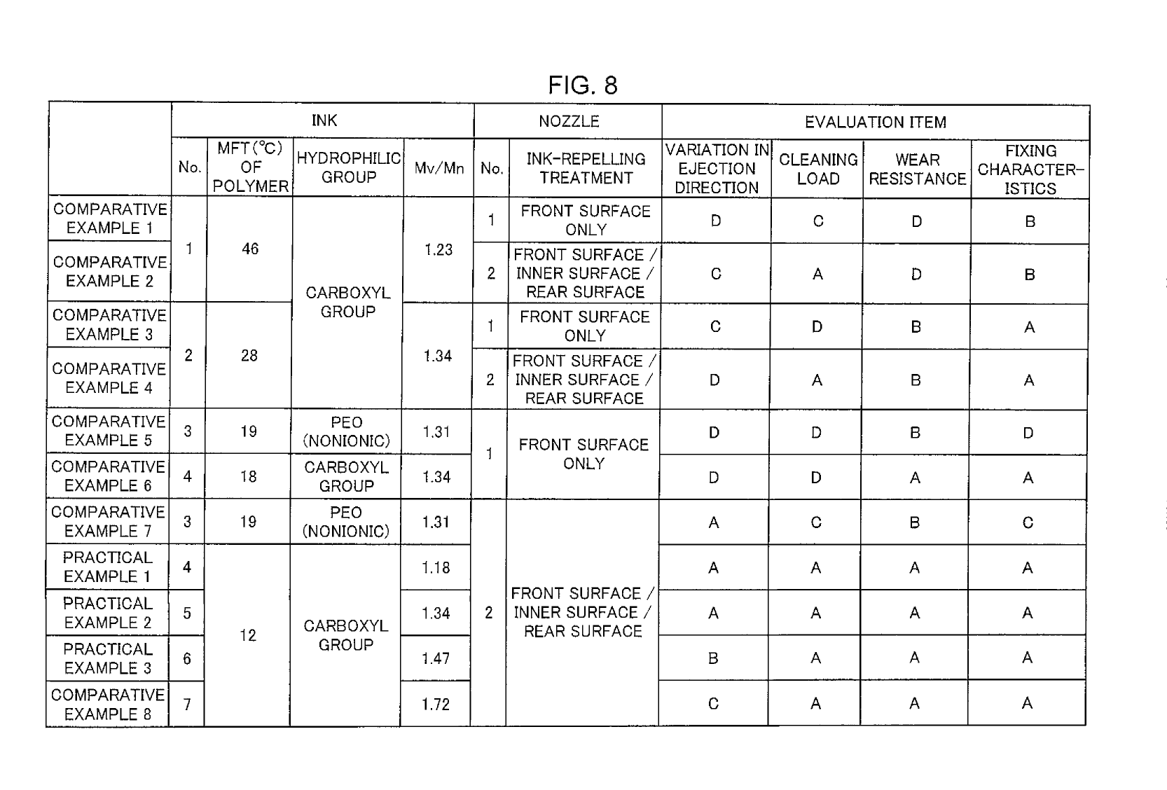

FIGS. 8 to 12 are tables showing the results of the above-described evaluations. As shown in FIG. 8, it was confirmed that, in order to satisfy all of the factors of stable ink ejection characteristics, reduction of the nozzle cleaning load, and good wear resistance characteristics and fixing characteristics, it is necessary to satisfy a plurality of conditions, namely, it is necessary that an ink-repelling film be provided on the front surface of the nozzle plate, the inner surfaces of the nozzle holes, and the peripheral region of the nozzles, and that the polymer particles contained in the ink have a minimum film forming temperature of 25° C. or less, include a carboxyl group as a hydrophilic group, and have a ratio of the volume-average particle size with respect to the number-average particle size of 1.5 or less. If any one or all of these conditions is not satisfied, then satisfactory results cannot be obtained in respect of all of the characteristics described above.

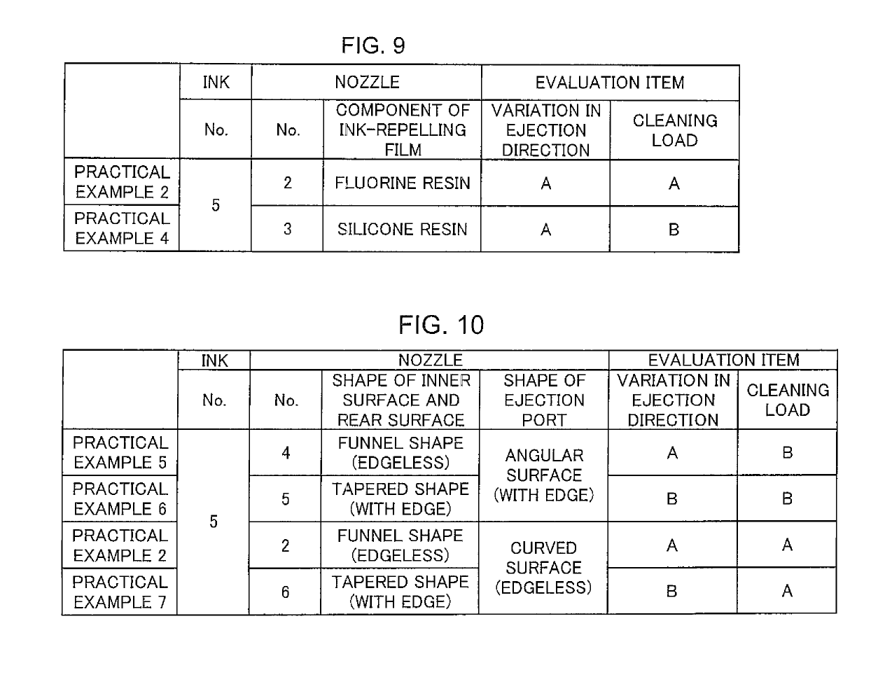

As shown in FIG. 9, by adopting an ink-repelling film containing a fluoropolymer (also referred to as “fluorine resin”), it was possible to reduce the cleaning load. Moreover, as shown in FIG. 10, by forming the edge portion of the nozzle ejection port and the shape from the inner surface of the nozzle to the rear surface of the nozzle plate as a curved surface, it was possible to stabilize the ink ejection characteristics, and it was also possible to reduce the cleaning load.

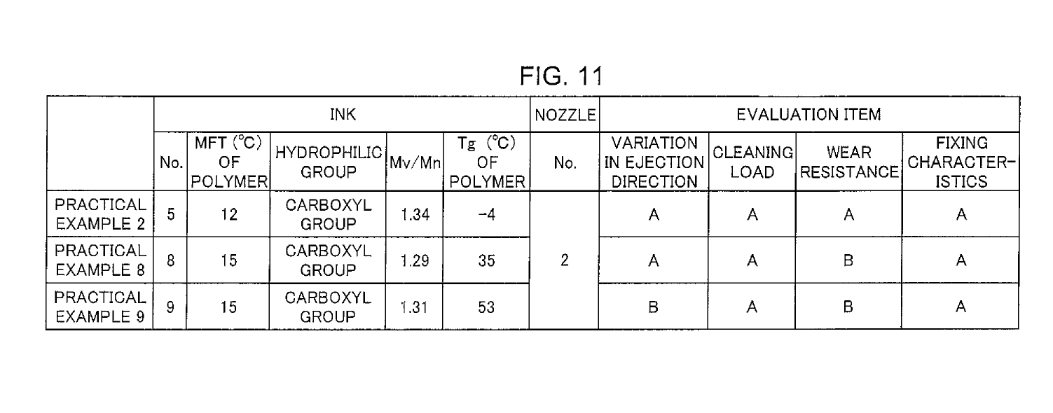

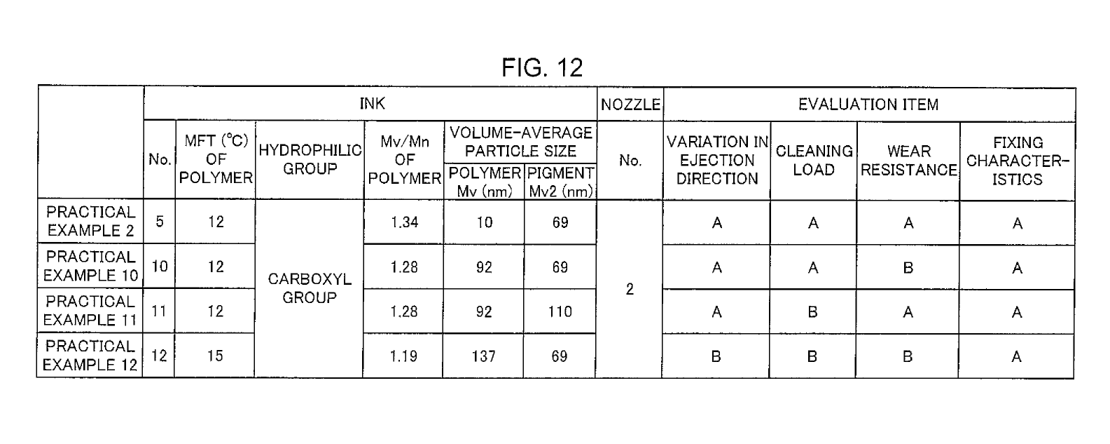

As shown in FIG. 11, by setting the glass transition temperature (Tg) to a low temperature, the ejection direction is stabilized. Furthermore, as shown in FIG. 12, it was confirmed that the finer the particle size of the polymer particles and the pigment particles, the better the evaluation results.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet image forming method of forming an image on a recording medium, comprising the step of:
ejecting an ink composition through a nozzle hole onto the recording medium so that the image is formed on the recording medium, wherein;
the ink composition contains coloring material particles and polymer particles, the polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5; and
the nozzle hole is provided in a nozzle plate which is uniformly coated with an ink repelling film on a front surface of the nozzle plate, an inner surface of the nozzle hole and a part of a rear surface of the nozzle plate surrounding the nozzle hole, the ink repelling film having properties to repel the ink composition.

2. The inkjet image forming method as defined in claim 1, wherein the ratio Mv/Mn is not less than 1 and not greater than 1.35.

3. The inkjet image forming method as defined in claim 1, wherein the anionic hydrophilic functional group includes a carboxyl group.

4. The inkjet image forming method as defined in claim 1, wherein the ink repelling film contains a fluoropolymer.

5. The inkjet image forming method as defined in claim 1, wherein the nozzle plate has a curved surface at a boundary between the inner surface of the nozzle hole and the front surface of the nozzle plate.

6. The inkjet image forming method as defined in claim 1, wherein the nozzle plate has a curved surface at a boundary between the inner surface of the nozzle hole and the rear surface of the nozzle plate.

7. The inkjet image forming method as defined in claim 1, wherein the polymer particles have a glass transition temperature Tg of not higher than 50° C.

8. The inkjet image forming method as defined in claim 1, wherein the polymer particles have the volume-average particle size of not greater than 100 nm.

9. The inkjet image forming method as defined in claim 1, wherein the coloring material particles have a volume-average particle size of not greater than 100 nm.

10. The inkjet image forming method as defined in claim 1, wherein the polymer particles have the volume-average particle size not greater than a volume-average particle size of the coloring material particles.

11. An inkjet image forming apparatus which ejects an ink composition onto a recording medium to form an image on the recording medium, the inkjet image forming apparatus comprising:
a nozzle plate provided with a nozzle hole through which the ink composition is ejected, the nozzle plate being uniformly coated with an ink repelling film on a front surface of the nozzle plate, an inner surface of the nozzle hole and a part of a rear surface of the nozzle plate surrounding the nozzle hole, the ink repelling film having properties to repel the ink composition,
wherein the ink composition contains coloring material particles and polymer particles, the polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5.

12. An ink composition used in an inkjet image forming apparatus which includes a nozzle plate provided with a nozzle hole, the nozzle plate being uniformly coated with an ink repelling film on a front surface of the nozzle plate, an inner surface of the nozzle hole and a part of a rear surface of the nozzle plate surrounding the nozzle hole, the ink repelling film having properties to repel the ink composition, the ink composition comprising:
coloring material particles; and
polymer particles including an anionic hydrophilic functional group, and having a minimum film forming temperature of not higher than 25° C. and a ratio Mv/Mn of a volume-average particle size Mv to a number-average particle size Mn of not less than 1 and not greater than 1.5.
